(19) United States
(12) Patent Application Publication
(10) Pub. No.: US 2004/0050339 A1
(43) Pub. Date: Mar. 18, 2004

(54) Pet bed convertible to pet carrier

(76) Inventors: Debra L. Johnson, Raleigh, NC (US); Thomas D. Johnson, Raleigh, NC (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/627,898

(22) Filed: Jul. 25, 2003

Related U.S. Application Data
(60) Provisional application No. 60/410,356, filed on Sep. 13, 2002.

(51) Int. Cl. A01K 31/07

(52) U.S. Cl. 119/453

(57) ABSTRACT

A pet basket is described. The basket acts as a pet bed, and a hemispherical cover is attachable to the pet bed to create a pet carrier. The cover is designed to allow the animal to have a view of the surroundings while securely transported in the carrier.

### CLAIM OF PRIORITY

This U.S. Patent application claims priority to U.S. Provisional application No. 60/410,356, filed Sep. 13, 2002, entitled “PET BED CONVERTIBLE TO PET CARRIER” by Debra L. Johnson and Thomas D. Johnson.

### FIELD

The invention relates to pet carriers. More specifically, the invention relates to a pet bed convertible to a pet carrier.

### BACKGROUND

There has long been recognized a need to provide a device to carry and transport pets. Many devices have been developed for this purpose. Traditional devices completely enclose the pet in a carrier that provides only limited visibility for the pet during transport. Additionally, most pet carriers are used by the pets only for transport, which may occur infrequently. For many pets, the forcible placement into a foreign cage of synthetic, unfamiliar material creates additional, unnecessary stress. This is accompanied by a subsequent stressful ride in a vehicle and/or a visit to a veterinarian. If the veterinarian is the destination of the transport, there is added difficulty with the need to forcibly remove the pet from the carrier prior to examination.

There has been some attempt to address the visibility problem for transport. For example, U.S. Pat. No. 5,785,003 issued to Jacobsen, et al. suggests a restraining strap to be fastened to a pet's collar to prevent escape. While this offers a completely unobstructed view, many pets, especially cats, would be distressed by a restraining strap to hold them in place.

Traditionally, pet carriers are generally devices with a rectangular base and nearly vertical side walls. Examples of such devices are found in U.S. Pat. No. 3,509,855 issued to Priddy, U.S. Pat. No. 5,901,664 issued to McKeman, U.S. Pat. No. 2,790,414 issued to Rossow, U.S. Pat. No. 6,394,036 issued to Bums, et al., and U.S. Pat. No. 6,345,591 issued to Richmond. While such a design may provide convenience for storage, it ignores the comfort of the animal that will occupy the carrier. For example, felines will generally curl up while in a bed or a carrier.

### BRIEF DESCRIPTION OF THE DRAWINGS

The figures below illustrate various embodiments of the invention by way of example, and not by way of limitation. In the figures, like reference numerals refer to similar elements.

FIG. 1 is one embodiment of a pet carrier with a cover attached.

FIG. 2 is one embodiment of a pet carrier secured in a vehicle by a vehicular restraining device.

FIG. 3 is one embodiment of a fastening device mounted to a cover.

FIG. 4 is one embodiment of a fastening device mounted to a container.

### DETAILED DESCRIPTION

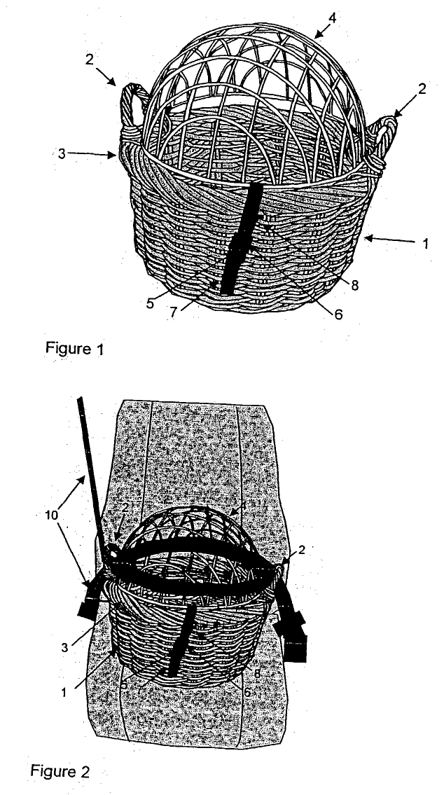

A pet bed convertible to a pet carrier is described. FIG. 1 is one embodiment of a pet carrier with a cover attached. Container 1 is a pet bed that may be used as a regular sleeping or resting place for a domestic animal. Container 1 should be sufficiently sturdy to support the weight of its occupant. In one embodiment, container 1 is a wicker basket, making a lightweight container that provides sufficient strength to securely hold a pet if the basket were to be lifted with the animal inside. For example, fibrous materials such as willow, rattan, bamboo, cane, and maize are commonly used materials in wicker baskets. In other embodiments, container 1 is a basket made of other natural and/or synthetic materials. Thus, container 1 has a base section and a wall rising from the base of container 1. The wall may rise vertically, or nearly vertically, horizontally enclosing the area within the wall above the base up to rim 3.

In one embodiment, the base is substantially circular in shape. Thus, in one embodiment, the base of container 1 is a circle, providing a round pet bed that has a constant diameter vertically from the base to rim 3, or a round pet bed that has a larger diameter at rim 3 than at the base of container 1. Such an embodiment is well-suited for smaller animals, especially those that prefer to curl up, such as felines. In another embodiment, the substantially circular base refers to a base that is elliptical in shape, so that container 1 will be longer than it is wide. As with the round embodiment, the elliptical embodiment may have the same size ellipsis at rim 3 as at the base of container 1, or the size of the ellipsis at rim 3 may be somewhat larger than the size of the ellipsis at the base of container 1.

Rim 3 includes handles 2 mounted to rim 3. In one embodiment, handles 2 are incorporated directly into rim 3, such as where rim 3 is constructed of a wicker material and handles 2 are woven into rim 3 of the same or similar material. Alternatively, handles 2 may be incorporated into rim 3 by means of mounting devices that secure handles 2 in place. For example, mounting devices could include rivets, a nut and bolt assembly, or an adhesive assembly. Handles 2 are preferably mounted on rim 3 so that the handles are opposite each other on rim 3 to provide for ease in carrying container 1.

Cover 4 is attachable to container 1 to convert container 1 from a pet bed to a pet carrier. Cover 4 is a substantially hemispherical, designed to match the shape and size of container 1 at rim 3. Thus, substantially hemispherical includes a half-sphere dome with a circular base, as well a dome that is somewhat elongated along two opposing sides making the shape of cover 4 to be two opposing quarter-spheres connected by a rounded cylinder. For example, if container 1 is round, cover 4 to attach properly to container 1 should be circular in at its base, and hemispherical in shape. Alternatively, if container 1 is elliptical, cover 4 should be elliptical at its base and rise into a modified hemispherical shape.

Fastening device 7 is mounted into the wall of container 1. Fastening device 7 may be mounted into the wall of container 1 by providing slits in the wall around which a strap at the mounting end of fastening device 7 can be wrapped. Fastening device may also be connected to a mounting device that is securely fixed into the wall. In one embodiment, fastening device 7 is a buckle assembly with a corresponding buckle assembly mounted on cover 4. In another embodiment, fastening device 7 may be an elastic material, such as a cord, that is mounted into the wall of container 1, and includes a mechanism that will attach securely to cover 4. Similarly, fastening device 7 could be the mechanism to receive the securing means of an elastic mounting assembly, such as the hook of a cord. Fastening device 7 is preferably of adjustable tension. Thus, for example, a buckle assembly may have adjustable straps. Fastening device 7 may be of an elastic or semi-elastic material, with a buckle end, or another means of attachment on the end, such as a hook.

Fastening device 8 is similar to fastening device 7, and is mounted onto cover 4. Fastening device 8 corresponds to, or mates with, fastening device 7 to attach cover 4 to container 1. In one embodiment, fastening device 8 is a buckle assembly with a corresponding buckle assembly mounted to the wall of container 1. In another embodiment, fastening device 8 may be a mechanism to receive a mounting portion of an elastic mounting assembly, such as a hook on a bungee-type cord mounted into the wall of container 1. Similarly, fastening device 8 may be an elastic mounting device attached securely to cover 4, with a mounting portion that attaches securely to a receiving portion on the wall of container 1. Fastening device 8 may also be of adjustable tension.

For convenience in attaching cover 4, note that three or more fastening devices 7 may be mounted equally spaced around the circumference of container 1 for a round container 1, and four, or more in groups of two, fastening devices 7 may be used for an elliptical container 1. Corresponding fastening devices 8 are mounted equally spaced around the circumference of cover 4 for both circular and elliptical designs. In this manner, if container 1 is round, corresponding cover 4 will be round, and attaching cover 4 will consist of simply aligning any corresponding fastening device pair 7 and 8, and all other corresponding fastening device pairs 7 and 8 will likewise align. This removes the element of orienting cover 4 to attach to container 1. Similarly, where container 1 is elliptical, cover 4 need only be lined up so that the elongated portion of cover 4 aligns with the elongated portion of container 1, and fastening device pairs 7 and 8 will align. This means that there is no “front” or “back” portion of an elliptical cover 4.

In order to provide for increased comfort for the pet occupant of container 1 when cover 4 is in place, cover 4 should provide a broad view of the surroundings of container 1. Therefore, in one embodiment, cover 4 has a wire-framed construction. The wire may be dipped or coated in vinyl or other plastic-like substance or powder coated. For example, the wire-framed construction may consist of a wire wrapped substantially circular as a base, with multiple parallel cross beams extending from points on the base, up and over to corresponding points on the other side of the base. Then other parallel cross beams are provided in a similar fashion to intersect the first set of parallel cross beams perpendicularly. The parallel cross beams on the inside will extend proportionally higher than the cross beams nearer the outside, resulting in a dome of substantially hemispherical shape, as discussed above. The parallel cross beams may be spaced, for example, about one to three inches apart. Such a construction provides for cover 4 to be strong and lightweight, while providing multiple large apertures to leave a mostly unobstructed 360 degree view for the pet occupant.

Note that a material other than metal, such as any of a variety of rigid or semi-rigid plastics, could be used to provide for a similar construction of cover 4. In another embodiment, cover 4 may be a substantially hemispherical dome made entirely of a transparent material, such as plastic. Multiple openings, such as holes may be spaced throughout the construction to provide for air and sound to pass easily through cover 4 to the area enclosed by container 1 and cover 4.

In one embodiment, container 1 includes a lining material that covers the base of container 1. The lining material can be an overlaid covering to insert into container 1 to provide a comfortable surface on which a pet can lay. Preferably the overlaid covering would include a backing that is impervious to liquids that will rest directly against the base of container 1, and a top portion to provide comfort to the pet. The backing can be of materials such as rubber or plastic. The top portion may be made of materials such as bedding material, carpeting, pet pillow, etc., many of which are known for use in a pet bed.

FIG. 2 is one embodiment of a pet carrier secured in a vehicle by a restraining device. Handles 2 may be made in such a way to allow for a restraining device, such as a seatbelt to secure container 1 by means of handles 2. This allows for container 1 to be securely positioned in a motor vehicle for convenient transport of a pet occupying container 1.

In one embodiment, handles 2 are designed to provide a sufficient opening for the larger end of a seatbelt to pass through the opening, allowing strap 10 of the restraining device to hold container 1 in place. Alternatively, handles 2 may be designed such that the handle attaches at one point to rim 3, but does not attach at the second point. Rather handles 2 may be made of a sufficiently sturdy material that may curve around and, even without attaching at a second point on rim 3, provide a handle for carrying container 1. In this way, even if the hole of handles 2 is not sufficiently large to allow the large end of restraining device 10 to pass through, the strap of restraining device 10 may be slid under the non-attached end of handles 2, allowing restraining device 10 to secure container 1 into place in a motor vehicle.

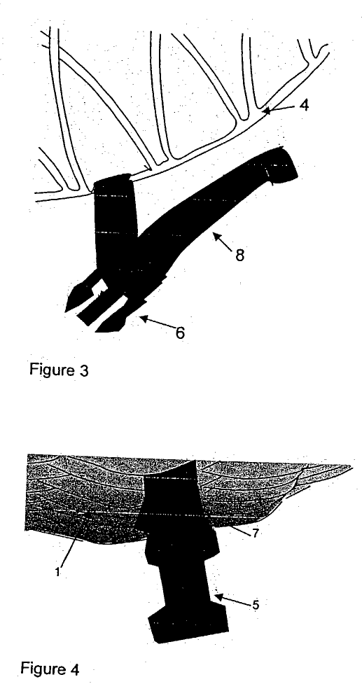

FIG. 3 is one embodiment of a fastening device mounted to a cover. In one embodiment, fastening device 8 is mounted to cover 4 by means of a looped portion of a strap at one end of fastening device 8. For example, if cover 4 is a wire-framed construction, the looped portion wraps around a wire of cover 4, such as the base of cover 4. Fastening device 8 may be permanently attached to cover 4 by stitching, gluing, riveting, etc., the looped opposing portions of the loop once it has been wrapped around a wire of cover 4. In another embodiment, cover 4 is not a wire-framed construction, but rather a more solid apparatus of transparent material. In such an embodiment, two slits can be made in parallel in the material of cover 4, or one slit can be made in parallel with the bottom edge of cover 4, and a similar strap of fastening device 8 may be fed through and looped around the solid portion of cover 4 that is between the two slits, or between the one slit and the bottom edge of cover 4.

In one embodiment, fastening device 8 includes attaching portion 6. In one embodiment, attaching portion 6 is the male end of a quick-release buckle assembly. In other embodiments, attaching portion 6 may be, for example, a hook end of an elastic tension-mount assembly, a loop section of a button-type assembly, etc. Attaching portion 6 of fastening device 8 corresponds to a similar portion of fastening device 7 mounted on the wall of container 1 to enable the secure attachment of cover 4 to container 1.

FIG. 4 is one embodiment of a fastening device mounted to a container. Fastening device 7 is mounted to the wall of container 1. Fastening device 7 is substantially the same as fastening device 8, being a corresponding piece of a fastening assembly. Thus, fastening devices 7 and 8 are substantially interchangeable, provided that the receiving, or female, sections of a fastening assembly are either all mounted on cover 4 or all on container 1, and the corresponding male sections are mounted opposite.

Fastening device 7 may be mounted to the wall of container 1 in a similar manner that fastening device 8 is mounted to cover 4. For example, a slit or pair of slits may be made in the wall of container 1 to provide a means of looping a mounting end of fastening device 7 to container 1. Note that when container 1 is a wicker basket, there may be sufficient spacing between levels of the wicker material to put a strap of fastening device 7 through the spaces, without the need to do anything else to provide slits. Alternatively, fastening device 7 may attach to a mounting device that is permanently mounted into container 1 by means of a nut and bolt assembly, rivet(s), adhesives, etc.

In one embodiment, fastening device 7 includes attaching portion 5. For example, attaching portion may be a receiving portion of a buckle assembly. In one embodiment, fastening device 7 may simply be a mounted receiving section that corresponds to fastening device 8 mounted on cover 4. For example, fastening device 7 may be a loop portion that corresponds to a hook attaching portion 6 of fastening device 8.

Reference herein to “one embodiment” or “an embodiment” means that a particular feature, structure or characteristic described in connection with the embodiment is included in at least one embodiment of the invention. However, not all features are required for every embodiment. Thus, the phrases such as “in one embodiment” and “in another embodiment” appearing in various places throughout the specification do not necessarily all refer to the same embodiment.

The descriptions provided herein of the various embodiments in the figures and otherwise are to be understood as providing illustrative embodiments of the invention, and not as narrowing the scope of the invention. Thus, the features described in the various embodiments herein may or may not be necessary to practice the invention, the scope of which is to be understood only by reference to the claims that follow.

What is claimed is:

1. An apparatus for holding an animal, comprising:
a container having a substantially circular base, a wall affixed to and rising from the base having a rim opposite the base;
at least one fastening device connected to the wall; and
a substantially hemispherically shaped cover having one or more counterpart fastening devices corresponding to the one or more fastening devices connected to the wall to attach the cover to the container.

2. An apparatus according to claim 1, wherein the container comprises a pet bed.

3. An apparatus according to claim 1, further comprising a covering for the base.

4. An apparatus according to claim 3, wherein the covering comprises a bedding material with a backing that is impervious to liquid.

5. An apparatus according to claim 1, further comprising handles mounted on the container.

6. An apparatus according to claim 1, wherein the container comprises a wicker basket.

7. An apparatus according to claim 6, further comprising handles woven into the basket.

8. An apparatus according to claim 1, wherein the cover comprises a wire frame substantially hemispherically shaped.

9. An apparatus according to claim 1, wherein the cover comprises transparent substantially hemispherically shaped assembly.

10. An apparatus according to claim 1, wherein the corresponding fastening devices comprise a male and female buckle connector assembly.

11. An apparatus according to claim 1, wherein the fastening devices connected to the wall comprise a fastening device with adjustable tension.

12. An apparatus for holding an animal, comprising:
a container having a substantially circular base, a wall affixed to and rising from the base having a rim opposite the base;
a substantially hemispherically shaped cover having one or more counterpart fastening devices corresponding to the one or more fastening devices connected to the wall to attach the cover to the container; and
fastening means to attach the cover to the container.

13. An apparatus according to claim 12, further comprising a covering for the base.

14. An apparatus according to claim 13, wherein the covering comprises a bedding material with a backing that is impervious to liquid.

15. An apparatus according to claim 12, further comprising handles mounted on the container.
